(19) United States
(12) Patent Application Publication
(10) Pub. No.: US 2006/0146012 A1
(43) Pub. Date: Jul. 6, 2006

(54) System and method for automatic display switching

(76) Inventors: Theodore R. Arneson, Ivanhoe, IL (US); Michael L. Charlier, Palatine, IL (US); John C. Neumann, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 11/028,411

(22) Filed: Jan. 4, 2005

(51) Int. Cl. G09G 5/00

(52) U.S. Cl. 345/156

(57) ABSTRACT

Disclosed herein is a system, method and apparatus including a first display screen component (302) configured to provide content in a real image display mode and a second display screen component (202) configured to provide content in a virtual image mode, a proximity sensor (318) and an automatic switching module (704) in communication with the proximity sensor (318) for activating the virtual image display screen component (202) and deactivating the real image display screen component (302) in the event the proximity sensor (318) detects an object such as a user (102) within a predetermined distance to the proximity sensor (318).

### CROSS REFERENCE TO RELATED APPLICATIONS

This application is related to the following U.S. patent applications:
“Foldable Electronic Device with Virtual Image Display” (Attorney Docket No. CS25637RL) by Theodore R. Arneson, David E. Devries, John C. Neumann, and Michael L. Charlier; and
“Electronic Device with Virtual Image Display” (Attorney Docket No. CS25640RL) by Theodore R. Arneson, John C. Neumann, and Michael L. Charlier.
   All of the related applications are filed on even date herewith, are assigned to the assignee of the present application, and are hereby incorporated herein in their entirety by this reference thereto.

### FIELD OF THE INVENTION

This invention relates in general to electronic devices and their display systems, and more specifically to a method and apparatus for displaying more than one mode on a display screen(s) and for automatically switching therebetween.

### BACKGROUND OF THE INVENTION

Wireless networks are used to transmit digital data both through wires and through radio links. Examples of wireless networks are cellular telephone networks, pager networks, and Internet networks. Such wireless networks may include land lines, radio links and satellite links, and may be used for such purposes as cellular phone systems, Internet systems, computer networks, pager systems and other satellite systems. Such wireless networks are becoming increasingly popular and of increasingly higher capacity. Much information and data is transmitted via wireless networks, and they are becoming a common part of people's business and personal lives.

The transfer of digital data includes transfer of text, audio, graphical and video data. Other data is and may be transferred as technology progresses. A user may interactively acquire the data (e.g., by sending commands or requests, such as in Internet navigation) or acquire data in a passive manner (e.g., by accepting or automatically transmitting data, using and/or storing data).

Wireless networks have also brought about a change in devices that send and receive data. A wide variety of handheld wireless devices have been developed along with wireless networks. Such handheld wireless devices include, for example, cellular phones, pagers, radios, personal digital assistants (PDAs), notebook or laptop computers incorporating wireless modems, mobile data terminals, application specific gaming devices, video gaming devices incorporating wireless modems, etc.

Wireless technology has advanced to include the transfer of high content data. Mobile devices now may include Internet access. However, limitations of a three inch screen size in an electronic device provide a less than complete web experience compared to those displayed by a 19 inch or greater computer screen. Internet providers have compensated for the portable device's screen size by limiting the data sent to Internet capable cell phones. Also, the mobile device may be configured to reduce the amount of data received.

Additionally, with the extended capabilities of cellular telephone technology, space inside the unit's housing is at a premium. Opportunities to reduce component volume and to provide additional and enhanced components or smaller cellular telephones are frequently considered.

### BRIEF DESCRIPTION OF THE DRAWINGS

FIG. 1 depicts a user operating an electronic device in a near-to-eye mode and a representation of the character of the image perceived by the user;

FIG. 2 depicts an optical element and certain components used to generate a high resolution virtual image;

FIG. 3 represents an electronic device having two substrates, one an optical element providing both a virtual image and a real or near-real image display LCD;

FIG. 4 represents an electronic device having a single substrate capable of operating in at least two modes;

FIG. 5 is a flowchart representing a method for switching between two viewing modes and switching on and off a touchscreen system;

FIG. 6 illustrates the content of two types of display output modes;

FIG. 7 is a diagram representing modules of the system;

FIG. 8 shows a plurality of substrates including a touchscreen system;

FIG. 9 shows a plurality of substrates including a touchscreen system in addition to other components; and

FIG. 10 represents an electronic device including an optical acoustic chamber.

### DETAILED DESCRIPTION

Disclosed herein are a method, system and apparatus for an electronic device capable of displaying output for multidimensional viewing of the content in a way that projects an image into the viewer's eye. An electronic device such as a mobile device or a cellular telephone is capable of receiving, processing, and displaying multidimensional data and displaying the data in the visual field of the viewer. In the current environment, on a display of the size in a typical cellular telephone, most web browsing is done using WAP protocol. Some 3 G handsets (typically larger display size as in a PDA) permit HTML browsing.

The device includes a substrate allowing an expanded field-of-view when the display screen is positioned in close proximity to the user's eye. The expanded field-of-view substrate provides a high resolution virtual image and is automatically activated when the device's proximity sensor detects an object within a predefined distance parameter. Until the unit's proximity sensor detects such an object, the substrate is inactive and is substantially transparent.

Additionally, the method, system and apparatus described herein further include a touch sensing system in parallel with the above-described high resolution substrate. A touchscreen is rendered inactive when the substrate allowing an expanded field-of-view is activated.

Moreover, the system and apparatus includes a sealed optical/acoustic chamber within the device's housing. The above-discussed optical components are supported within the housing of the mobile device by a structure that includes support for a speaker. The speaker support can also include vibration damping features to prevent image degradation when the speaker is used.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

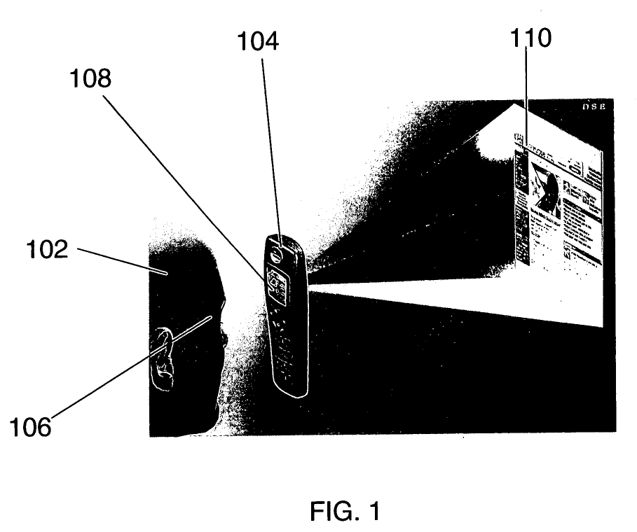

FIG. 1 depicts a user operating an electronic device in a near-to-eye mode and a representation of the character of the image perceived by the user. A user 102 is shown having an electronic device 104 within close or near proximity to his eye 106 (an object). The electronic device may be, for example, a mobile device as depicted in FIG. 1, such as a cellular phone, a pager, a radio, a personal digital assistant (PDA), a notebook or laptop computer incorporating a wireless modem, a mobile data terminal, an application specific gaming device, a video gaming device incorporating a wireless modem, etc. An electronic device also may be, for example, a non-mobile device such as a desk top computer, a television set, a video game, etc.

Depending upon the device, the multidimensional viewing of content may take place at different distances from the device. Here, an electronic device such as a cellular telephone with a small screen is discussed. A device with a larger screen may be used as well, and be viewed in the multidimensional viewing mode at a different distance. Any one of these may be in communication with digital networks and may be included in or connected to the Internet, or networks such as a local area network (LAN), wide area network (WAN), virtual private network (VPN), etc. Also, the data may be displayed on the screen from a non-networked data source such as a CD, DVD or a data stick or embedded in the handset memory.

The electronic device 104 of FIG. 1 may include a display screen 108 of a size having dimensions of a typical cellular telephone. The display screen size as shown in FIG. 1 is for illustration purposes and may be larger or smaller than that depicted in the drawings. FIG. 1 depicts, as a way of illustration, a virtual image projection 110 beyond the electronic device 104. The projection is intended to show the breadth of image the user 102 would experience by an enlarged field-of-view of the virtual image in the near-to-eye operation of the electronic device 104. The image is projected into the viewer's eye, displaying the image in the visual field of the viewer. In the near-to-eye mode of operation, an image is projected into the eye, which creates an enhanced-field-of-view. The enhanced-field-of-view has a higher resolution than a standard or real or near-real image (herein after referred to as a real image) viewed in a normal viewing mode. Also, the screen size appears larger in the near-to-eye mode. Therefore, the user 102 sees more content in the near-to-eye mode.

In the normal viewing mode, a user 102 typically may hold the electronic device 104, in this example, a cellular telephone having display 108, between about 45 cm and 60 cm (approximately 18 inches to 24 inches) from his or her eyes. In the technology described herein, a real image display is active in the electronic device 104 in the normal viewing mode. In the near-to-eye mode for a cellular telephone, a user 102 holds the display 108 at approximately 1 to 4 inches (around 2.5 cm to 10 cm) from his or her eyes. However, the distance for viewing depends upon, for example, the type of display used, the user's visual abilities, the user's preference, the configuration of the device, the size of the display and the type of data.

In the example shown, the display screen's 108 diagonal display aperture (or image's size as it appears in the light guide optical substrate) is 1.5 inches (about 3.5 cm). For a field of view of 30 degrees (on the diagonal), this may correlate to viewing a computer/laptop screen of 20 inches (48 cm) from a distance of approximately 34 inches (80 cm).

The virtual image display may be triggered at a distance less than the diagonal screen size, depending on the particular display implementation. Larger screens may have a shorter distance to trigger a virtual image while smaller screens may have a longer distance to trigger the virtual images.

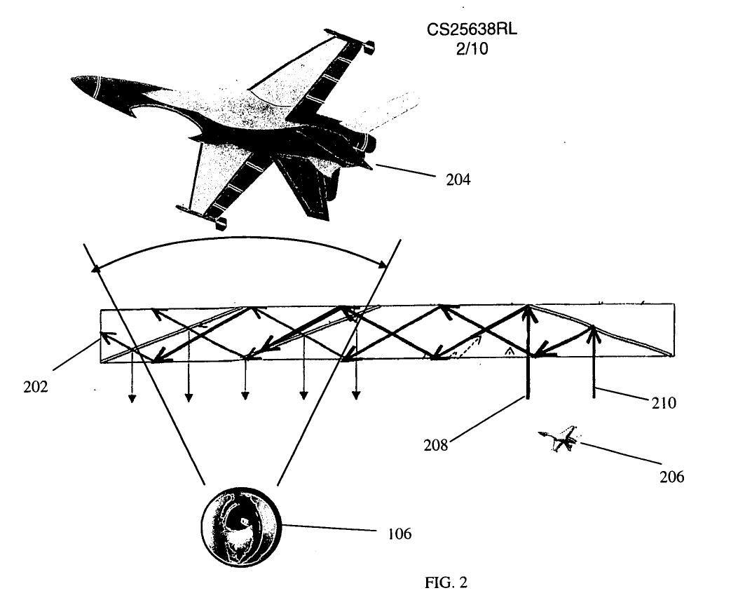

In the near-to-eye mode depicted in FIG. 1 the user may receive data at high speed data rates that may enable a rich, high resolution multimedia experience. The display screen 108 has one or more components that enable the expanded field-of-view. FIG. 2 depicts an optical element 202 and certain components used to generate a high resolution virtual image. In the optical element 202, the image 204 focal plane is essentially at infinity, providing a virtual image. As discussed above, the optical element 202 provides a field-of-view enhancing experience for the viewer because the image is projected into the eye.

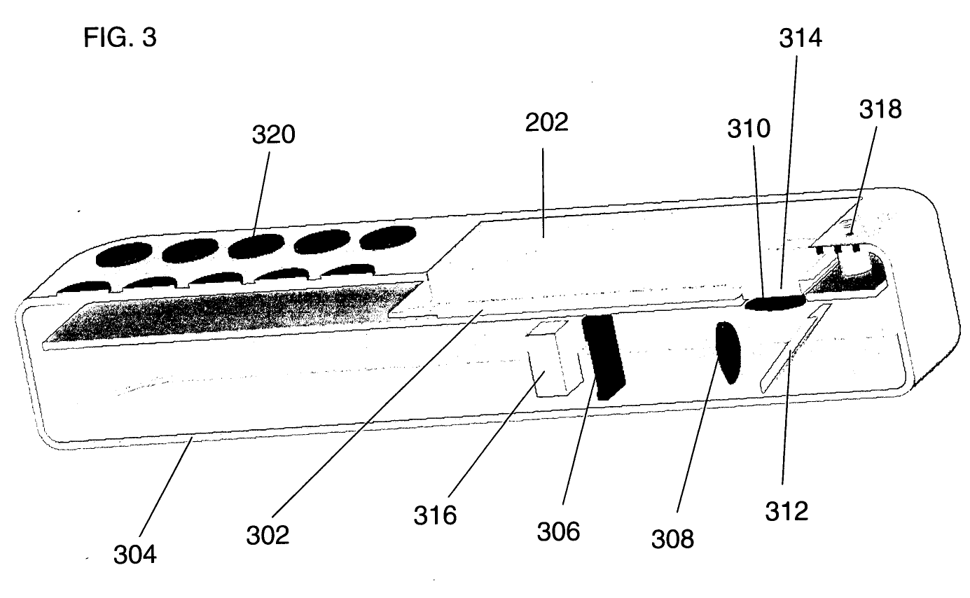

FIG. 3 represents an electronic device having two substrates, one an optical element 202 providing a virtual image and a real or near-real image LCD 302. An image 206 is transmitted via microdisplay VGA+ 306 (or lower (for real image) or higher resolution (for virtual image)) and is routed in the direction of 208 and 210 by a collimator 314 and then directed by the optical element 202. In one embodiment, a substrate-guided optical device or light guide product by Lumus having a thin and substantially transparent optical plate with partially reflective internal surfaces is used in this near-to-eye mode. Other products, that is, those providing an expanded the field-of-view when viewed more closely than normal viewing of an electronic device screen may be used as well.

Referring to FIG. 3, the transparent optical element 202 is positioned over a real image LCD 302 within the housing 304 of the electronic device. In this manner, when the virtual image generated by the microdisplay 306 delivered through transparent optical element 202 is deactivated, the real image LCD 302 may be viewed therethrough. On the other hand, when the virtual image for display by transparent optical element 202 is generated by the microdisplay 306, the real image generated for real image LCD 302 is deactivated. Then in the near-to-eye mode the user perceives the virtual image displayed by the transparent optical element 202. Alternatively, in another embodiment, the normal viewing mode and the near-to-eye mode may be viewed simultaneously in a combination mode. Effects such as 3D simulation, mood shading, as well as other effects may be available in the combination mode.

In one embodiment, a proximity sensor 318 is in communication with a switch for activating the microdisplay 306 and the virtual image subsequently viewed on the optical element 202 of the virtual image display when the proximity sensor 318 detects an object (a user) within a predetermined distance to the proximity sensor 318. Also, this event deactivates the real image LCD 302. Conversely, in the event that the proximity sensor does not detect an object within the predetermined distance to the proximity sensor, the image for the real image LCD 302 is activated and the image for the optical element 202 is deactivated. A hard or soft key as part of keypad 320 may also be used to permit the user to manually change modes as well.

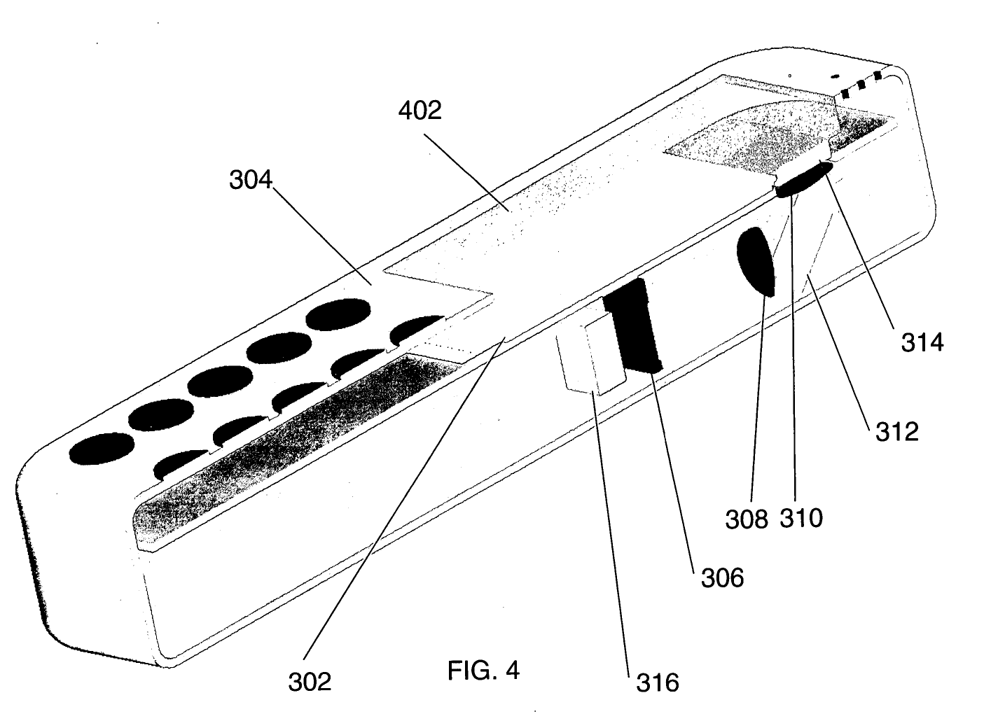

In some instances, either display may have varying degrees of display capability, and the activation and deactivation of either component may be in stages. Additionally, in another embodiment, the optical element 202 may include varying degrees of imaging, that is, from a real image to a virtual image, so that the real image LCD is not included in the housing. FIG. 4 represents an electronic device having a single substrate capable of operating in at least two modes. FIG. 4 shows a single display element that is an optical element 402 capable of outputting both a real or near-real image display and a virtual image.

Returning to FIG. 3, the optics and electronics are supported by a structure within the housing. The optics may include the micro display VGA+ 306, converging lenses 308 and 310, a reflector 312 (or prism), and a collimator 314. A backlight 316 and support are also represented in this figure. The proximity sensor 318 is shown as positioned at the far top end of the housing so that the sensor 318 senses the user's forehead. The sensor can be of any type and positioned in any location that provides input to the switching mechanism.

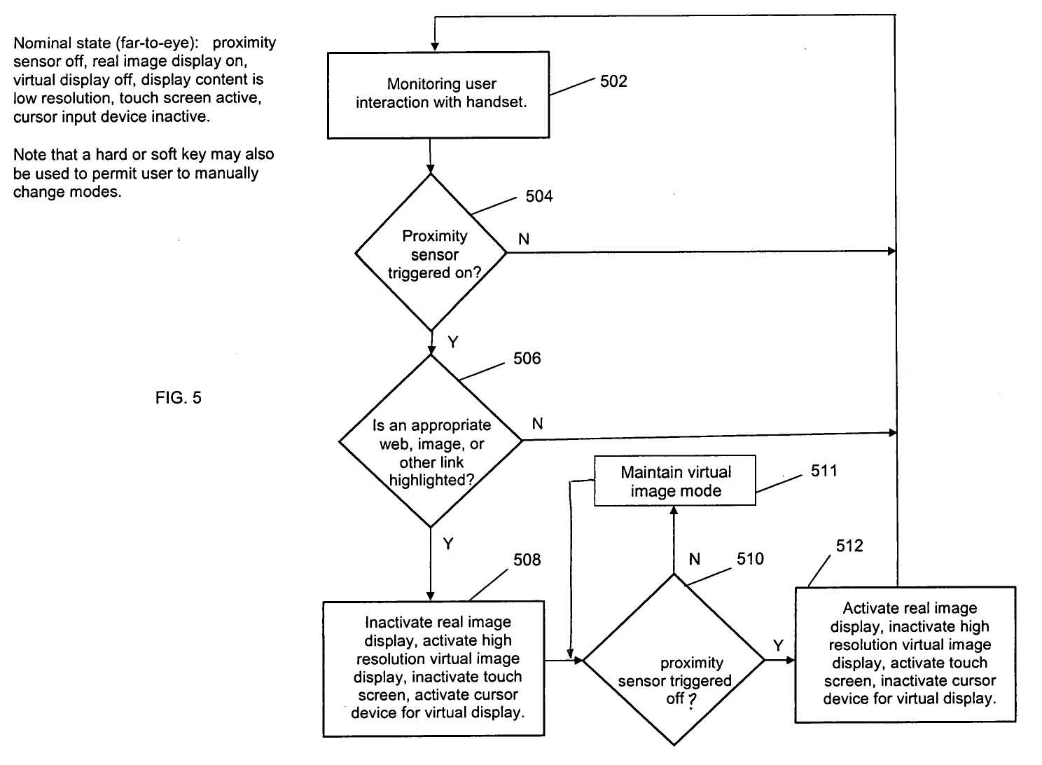

FIG. 5 is a flowchart representing a method for switching between two viewing modes and switching on and off a touchscreen system. The method includes activating and deactivating images that are displayed by the two display layers 202 and 302 as shown in FIG. 3. This method is also applicable to those electronic devices including more than two modes.

The sensor 318 monitors the user interaction with the handset 502. If there is an object within a predetermined distance from the handset 502, the proximity sensor is triggered on 504. The system will then query whether there is data available for a virtual image to be displayed. That is, the system queries whether there an appropriate website download, image or other link highlighted on the real image LCD display 506. Additionally, another setting may allow the user to stay in near-to-eye mode, i.e. over ride the proximity sensor switch, while, for example, waiting for a page to load or to put the handset down to attend to another task.

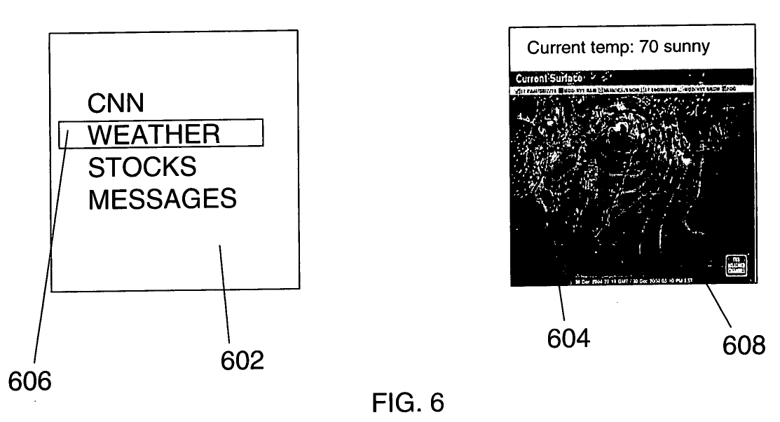

Briefly turning to FIG. 6, the content of two types of display output modes are shown. Display 602 is in a normal viewing mode that is the output of real image LCD 302. The display 604 is in a near-to-eye mode that is the output of the optical element 202. Display 602 indicates that the user has accessed web links for CNN, weather, stocks and messages. The field is scrolled so that “weather” 606 is highlighted. Display 604 includes a virtual image 608 of a detailed weather map. The virtual image may occupy the entire display 604 and show a detailed weather map or video of a weather map changing over time captioned by text “current temp 70 degrees and sunny.”

The interactivity of the system may be accomplished by the use of a touchscreen. Therefore, the user may touch the screen at “weather” which is highlighted in FIG. 6. Alternatively, the mobile device may have a hard or soft select button, for example, on the key pad 320 as shown in FIG. 3. Other input methods of interactivity may include for example, voice commands.

Now returning to FIG. 5, if there is an appropriate web link, image or other link highlighted, the system deactivates the real image LCD 302 and activates the microdisplay 306 to transmit a virtual image that is passed through the optical element of the virtual image display 202 at step 508. Highlighting a link includes brightening or changing the color, underlining, bolding, increasing the type size or otherwise displaying an item. When scrolling though a list on an electronic device, the item scrolled is typically highlighted in some way. However, if a touchscreen is used, tapping on an item on the screen will typically highlight the item. Double-taps will activate that link (e.g., open the item, dial the number, or similar action).

In addition or as an alternative to visual highlighting, voice control may operate to highlight or activate a link. The user might say “scroll” to highlight the first item in a list. The user could then say “next,” “next,” and “select” to activate a link.

In an embodiment including a touchscreen for interactivity, a touchscreen would be deactivated when the microdisplay 306 is activated to transmit a virtual image that is passed through optical element 202 also at step 508. The mode of optical element 202 would remain on until the proximity sensor is triggered off at step 510. As long as the proximity sensor is on, that is, the proximity sensor is not triggered off at 510, the virtual image mode is maintained at 511. When the sensor is triggered off at 512, the real image mode is activated, the high resolution virtual image display of the virtual image mode is deactivated, the touchscreen is activated and a cursor of the device may be used during normal mode.

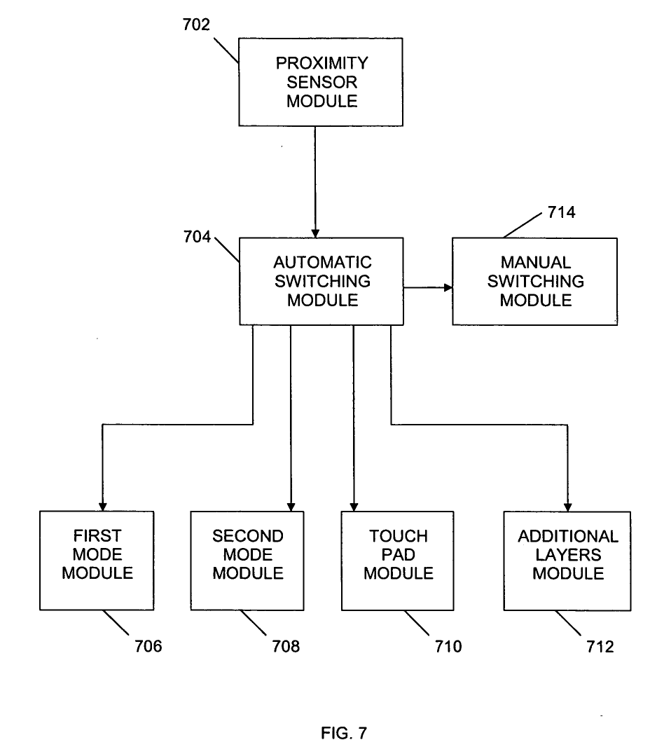

FIG. 7 is a diagram representing modules of the system. The modules shown in FIG. 7 include a proximity sensing module 702 in communication with one or more switching modules 704 that may operate to switch on and off a first mode module 706, a second mode module 708, the touchscreen system module 710 and other components as described above 712. The first module may incorporate functionality for the normal viewing mode and second module may incorporate functionality for the near-to-eye mode. A manual activation module 714 may be provided in addition to the automatic switching module.

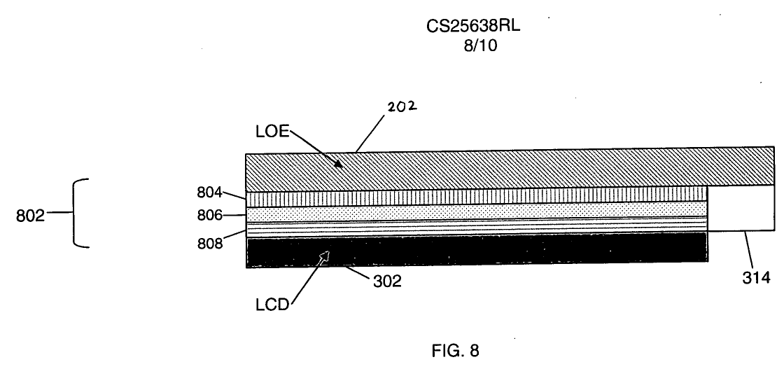

Turning to FIG. 8, one embodiment of the touchscreen referred to in FIGS. 5, 6 and 7 is shown. FIG. 8 shows a plurality of substrates including a touchscreen system. Optical element 202 is positioned on top of the touchscreen layer arrangement 802 which is on top of real image LCD layer 302 which are generally in parallel. In one embodiment the touchscreen 802 includes a trace array (columns) 804, a spacer 806 and trace array (rows) 808. In this embodiment, the touch sensing system 802 would be used as navigation for the active display, much like a traditional touchscreen. Alternatively, the touchscreen system 802 could be placed on top of the optical element 202. The touchscreen system 802 is capacitive. Capacitive touchscreens only require a proximal “touch.” In this way, the capacitive touchscreen element may be placed behind other layers. The electrical characteristics of the human body are passed through the finger and the air gap between the finger and the capacitive touchscreen. If a stylus is used, it should contain metal to work with a capacitive touchscreen.

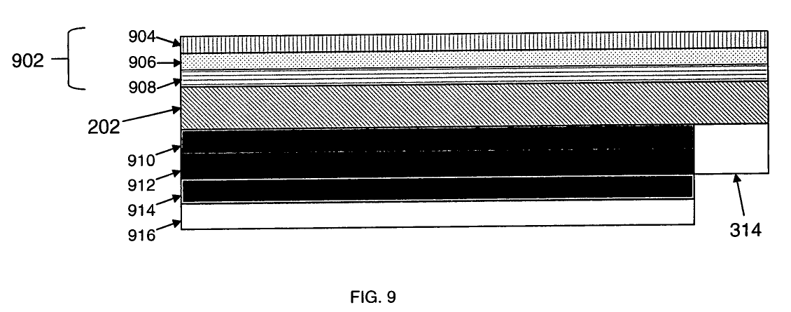

In another embodiment shown in FIG. 9, three elements of a resistive layer are placed over optical element 202. A resistive touchscreen requires physical contact to activate. Moreover, the term “touchscreen” refers to any touch device that is clear. A touchpad used in the general sense is not necessarily clear. In this case, the capacitive layer 802 of FIG. 8 and the resistive components 902 of FIG. 9 are clear because they are used in conjunction with an LCD layer 302 and an LOE layer 202. In FIG. 8, the capacitive touchscreen 802 is positioned under the LOE layer 202 and under the LCD layer 302. In FIG. 9, the resistive components are positioned over the LOE layer 202.

FIG. 9 shows a plurality of substrates including a touchscreen system 902. As shown in FIG. 9, the resistive components 902 include resistive layers 904 and 908 combined with adhesive layer 906. When touched, resistive layers 904 and 908 are moved close enough together so that a current passes between them to activate the touch screen.

Also shown in FIG. 9 is an alternative layer to the LCD layer 302. A polymer dispersed liquid crystal (PDLC) display including layers 910, 912, 914 and 916 is shown. The PDLC used in the touch screen application provides background for the touch screen. The outlines of the keys of a keypad may therefore be continuously visible. The layers include masking layer 910 acting as glue, a polymer dispersed liquid crystal (PDLC) layer 912 that allows a change in the background, a reflective dye 914 for providing different color backgrounds, and an electro luminescence (EL) 916 (segmented) transforming voltage into light.

In the configuration of FIG. 9, in normal viewing mode the key pad system acts as a keypad within the touch sensing system capturing events and the optical shutter with its back lit cells PDLC/EL 912/916 denote active areas (“keys”). In the virtual image display mode, the PDLC/EL 912/916 combination could be turned off to provide a neutral background.

The touch sensing system 802 shown in FIG. 8 may not typically be used as input during the display of a virtual image during the near-to-eye mode because it could obstruct the display. In another embodiment, the touchscreen system 902 may be provided to part of the screen, that is, the whole may be divided into smaller sections positioned adjacent one another, so that a smaller section may be activated during near-to-eye mode. This arrangement may be more useful in larger screen applications than in the cellular telephone application. In this arrangement a portion of the touchscreen system 802 may be activated during the near-to-eye mode.

As an alternative to a partially activated touchscreen, the keypad on a cellular telephone may be used to drive a cursor. As mentioned above, a voice command may be used to drive a cursor. In this way, the touchscreen 802 need not be activated during the near-to-eye mode.

The combination of substrates as discussed above provides at least one arrangement that may be thin enough to include other objects nearby within the housing. The thickness of optical element 202 is typically 4 mm. The real image LCD may have a thickness between 3 and 4 mm, and the touchscreen system 802 is approximately 0.1 mm in thickness. The arrangement with the lightguide optical substrate 202 and the associated components discussed above are smaller than those used in traditional optical devices. Traditional optical devices include lens eyepieces or waveguide elements. Accordingly, the system and apparatus as provided herein may occupy less space than a traditional display substrate configuration.

The optical component support structure supporting the optical and substrate elements described above with reference to FIGS. 3, 4, 8 and 9 within the housing may act as an acoustic chamber that includes support for an object such as a speaker. In this way, the optical support module may eliminate the need for a traditional, separate chamber and the associated volume requirements. In this way, one or more speakers 1002 may be placed in the sealed optical chamber of housing 304.

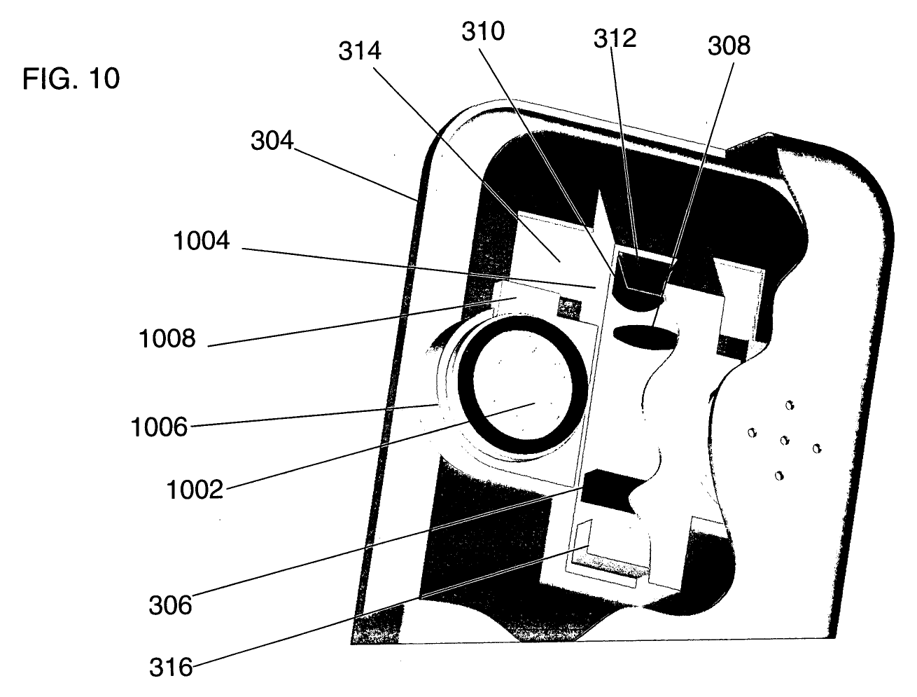

FIG. 10 represents an electronic device including an optical acoustic chamber. The housing 304 includes an optics support 1004 onto which there is integrated a speaker support 1006. The housing 304, the optics support 1004 and the speaker support 1006 may be composed of one or more pieces. In another embodiment a damping element 1008 may be provided.

In FIG. 10, singular (or twin) 16 mm multi-function transducers (MFTs) and a 6 cc acoustic volume are shown. The speaker support 1006 may allow one or more MFTs (or speakers) 1002 to utilize the unused volume of the housing 1004 as an acoustic-chamber. The optical system as described above including the backlight 316, microdisplay 306, lens(es) 308 and 310 and reflectors(s) 312 are supported by a structure 1004 to provide image integrity in a variety of conditions.

Damping element 1008 integrated with speaker support 1006 may be provided to prevent image degradation when the speaker is used. If the speaker is vibrating, items which are directly connected to it may vibrate also. Thus, in the embodiment described herein, the microdisplay 306 may vibrate and the image may not appear clearly unless the vibrations are damped. Also, the life of the microdisplay 306 may be reduced by undamped vibrations. By providing over-molding of an elastomer onto the locations of the support 1006 that support the microdisplay 306 and other elements, the transmission of vibrations to these devices may be reduced. Other materials could include rubber, silicon and urethane. Materials with a durometer range from 40A to 60A may be utilized.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. An electronic device, comprising:
a first display screen component configured to provide content in a first display mode;
a second display screen component configured to provide content in a second display mode;
a proximity sensor; and
a first switch in communication with the proximity sensor for activating the first display mode when the proximity sensor detects an object within a predetermined distance to the proximity sensor.

2. An electronic device as recited in claim 1 wherein:
the first display screen component is configured to provide content in a field-of-view enhancing manner.

3. An electronic device as recited in claim 2 wherein the first switch is for deactivating the second display mode when the proximity sensor detects an object within a predetermined distance to the proximity sensor.

4. An electronic device as recited in claim 2 wherein the second display screen component is configured to provide content in a real image manner.

5. An electronic device as recited in claim 1 further comprising:
a touch sensing system.

6. An electronic device as recited in claim 5 further comprising:
a second switch in communication with the touch sensing system for deactivating the touch sensing system when the proximity sensor detects an object within the predetermined distance to the proximity sensor.

7. An electronic device as recited in claim 6 wherein the second switch and the first switch are a single switch.

8. An electronic device as recited in claim 5 wherein the first display screen component, the second display screen component and the touch sensing system are positioned in parallel.

9. An electronic device as recited in claim 5 wherein the touch sensing system is positioned on top of the first display screen component.

10. An electronic device as recited in claim 5 wherein the touch sensing system is positioned underneath the first display screen component.

11. An electronic device as recited in claim 1 wherein the first display screen component and the second display screen component are positioned in a housing adjacent to an optics support module.

12. An electronic device as recited in claim 11 wherein the optics support module includes an acoustic damper.

13. An electronic device as recited in claim 1 wherein the first switch deactivates the first display mode when the proximity sensor fails to detect an object within a predetermined distance to the proximity sensor.

14. An electronic device as recited in claim 1 wherein the first switch activates the second display mode when the proximity sensor fails to detect and object within a predetermined distance to the proximity sensor.

15. An electronic device as recited in claim 1 wherein the first display screen component overlays the second display screen component.

16. A method for operating a display screen of an electronic device, the display screen having a first display screen mode and a second display screen mode, the method comprising:
detecting an object within a predetermined distance from the display screen of the electronic device; and
automatically switching from the first display screen mode to the second display screen mode when the object is detected within the predetermined distance.

17. A method as recited in claim 16, further comprising:
automatically switching from the second display screen mode to the first display screen mode when the object fails to be detected within the predetermined distance.

18. A method as recited in claim 16 wherein
the first display screen mode provides content in a real image manner; and
the second display screen mode provides content in a field-of-view enhancing manner.

19. A method as recited in claim 16 wherein the electronic device further comprises a touch sensing system, the method further comprising:
automatically switching the touch sensing system off when the object is detected within the predetermined distance.

20. An electronic device system including a display screen having first and second modes, the first mode for normal viewing, the second mode for near-to-eye viewing, comprising:
a proximity sensing module for detecting an object's distance from the display screen; and
a switching module for switching between the first mode and the second mode depending upon an object's distance from the display screen.

21. A system as recited in claim 20, further comprising:
a decision module for determining whether content transmitted to the system is appropriate for near-to-eye viewing.

22. A system as recited in claim 20 further comprising:
a touch sensing module for providing navigation capability when the first mode is activated.

23. A system as recited in claim 20 further comprising:
a manually activated switching module for manually switching between the first mode and the second mode.

24. A system as recited in claim 20 further comprising a housing unit, wherein the display screen is supported in a housing adjacent to an optics support structure with a support structure to secure an acoustic speaker.

25. A system as recited in claim 24 wherein the support structure includes a damping element.
